(19) United States
(12) Patent Application Publication
(10) Pub. No.: US 2012/0151821 A1
(43) Pub. Date: Jun. 21, 2012

(54) RE-USABLE BAG TRAP FOR INSECTS

(76) Inventors: Ervin Kovacs, Vancouver (CA); Alan L. Vaudry, Victoria (CA); Mark Leighton Foster, Victoria (CA); John Harvey Borden, Burnaby (CA)

(21) Appl. No.: 13/063,607

(22) PCT Filed: Sep. 10, 2009
(86) PCT No.: PCT/CA2009/001273

§ 371 Date: Jul. 5, 2011

Related U.S. Application Data
(60) Provisional application No. 61/096,737, filed on Sep. 12, 2008.

(51) Int. Cl. A01M 1/10

(52) U.S. Cl. 43/107

(57) ABSTRACT

This invention relates to traps for flying insects, and in particular, relates to a self-supporting and re-usable trap for wasps, yellowjackets and flies. A trap for insects comprising a bag having a first generally flat collapsed configuration for storage and a second expanded configuration for operation thereby forming an internal chamber for trapping insects. The bag includes a first side wall and a second opposite the side wall and at least one entry portal for insects, said first circular entry portal penetrating said first side wall and communicating with the chamber. The trap can include a suitable attractant for attracting insects to the entry portal.

### FIELD OF THE INVENTION

This invention relates to a novel design of a trap for flying insects. In particular, the invention relates to a hangable or self-supporting and re-usable trap for wasps, yellowjackets and flies.

### BACKGROUND

Wasps are classified in the group Vespoidea. The wasps most frequently encountered by humans belong to the genera Vespula, Dolichovespula, and Vespa (yellowjackets and hornets). These pests are of medium size (10-25 mm), and are readily distinguished by the bands of black and yellow or white on their abdomens. The most aggressive species encountered is the German yellowjacket, Vespula germanica. These wasps have a habit of scavenging in city garbage cans. Wasps are capable of repeatedly stinging their victim as well as inflicting painful bites. Yellowjackets are a common sight in urban and rural areas throughout North America and are the most common stinging menace in many North American cities. In some cases, severe allergic reactions to the wasp venom have resulted in death.

Flies in many families, e.g. Muscidae, Calliphoridae, Anthomyiidae, constitute a nuisance whenever they are encountered by humans. They are also capable of transmitting a variety of diseases, and are recognized as a threat to public health. While the presence of flies in a person's dwelling is unwelcome, they are even less welcome in restaurants. The presence of flies is potentially dangerous in hospitals. Many chemical insecticides are used to control flies, and numerous traps of various designs are used to remove flies from man-made structures, and their environs.

A number of devices have been disclosed for trapping wasps and flies. One such device is disclosed in U.S. Pat. No. 4,551,941 by Schneidmiller. This device relies on a volatile olfactory attractant. Another device is exemplified in U.S. Pat. No. 6,637,149 by Bauer. This device appears to comprise a number of discrete parts and as a consequence would be expensive to manufacture and therefore costly to ordinary consumers.

US Patent Application 2005/0005503, Bragg, discloses a hanging fly trap in the form of an artificial plant basket. This device must be hung out of sight and so some effort is required to monitor the number of flies caught by the trap and then retrieve the trap for cleaning and replacement of adhesive surfaces.

There is a growing need for effective, safe and inexpensive traps for wasps and flies around human habitation.

### SUMMARY OF THE INVENTION

The invention is directed to a trap for insects comprising: a bag having a first generally flat collapsed configuration for storage and a second expanded configuration for operation thereby forming an internal chamber for trapping insects, said bag comprising a first side wall and a second opposite side wall; an entry portal for insects, said entry portal penetrating said first side wall and communicating with said internal chamber; and a suitable attractant in the bag for attracting insects to the entry portal.

The trap can include a second opposite entry portal for insects, the second circular entry portal penetrating the second side wall and communicating with the internal chamber.

The bag can be formed of a resilient plastic. The plastic can include a bonded barrier material. The one or more side walls can be transparent. The interior of the chamber can contain a fluid.

The bag can have a sealable top end. The bag can have a bottom surface comprising an oval-shaped bottom member having a longitudinal axis.

The longitudinal axis can comprise a fold line so that when the bag is in a generally flat configuration the oval-shaped bottom member folds symmetrically along the fold line and when the bag is in the expanded operating configuration the oval-shaped bottom member unfolds to form a self-supporting base.

The first and second transparent side walls can include a translucent, low reflective, rectangular or variously shaped appropriate portion having a colour suitable for attracting insects. The first portal and the second portal can be offset laterally from each other.

The fluid can be a predetermined volume of water for drowning insects, the predetermined volume of water stabilizing the trap when placed on a level surface. The water can contain an attractive chemical lure. An insect attractant can be located within the interior of the trap above the two portals.

The top region of the trap can include a releasable pressure sealing strip. The top region of the trap can include an eyelet which enables the trap to be suspended from an object.

### DRAWINGS

Exemplary embodiments are illustrated in referenced figures of the drawings. It is intended that the embodiments and figures disclosed herein are to be considered illustrative rather than restrictive.

FIG. 1 is a schematic elevation view of a side wall of one embodiment of the invention.

FIG. 2 is a schematic elevation view of the opposite side wall of the same embodiment as FIG. 1.

FIG. 3 is a schematic end view of one embodiment of the invention in a flattened configuration.

FIG. 4 is a schematic end view of one embodiment of the invention in an expanded configuration.

FIG. 5 is a bottom view of one embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

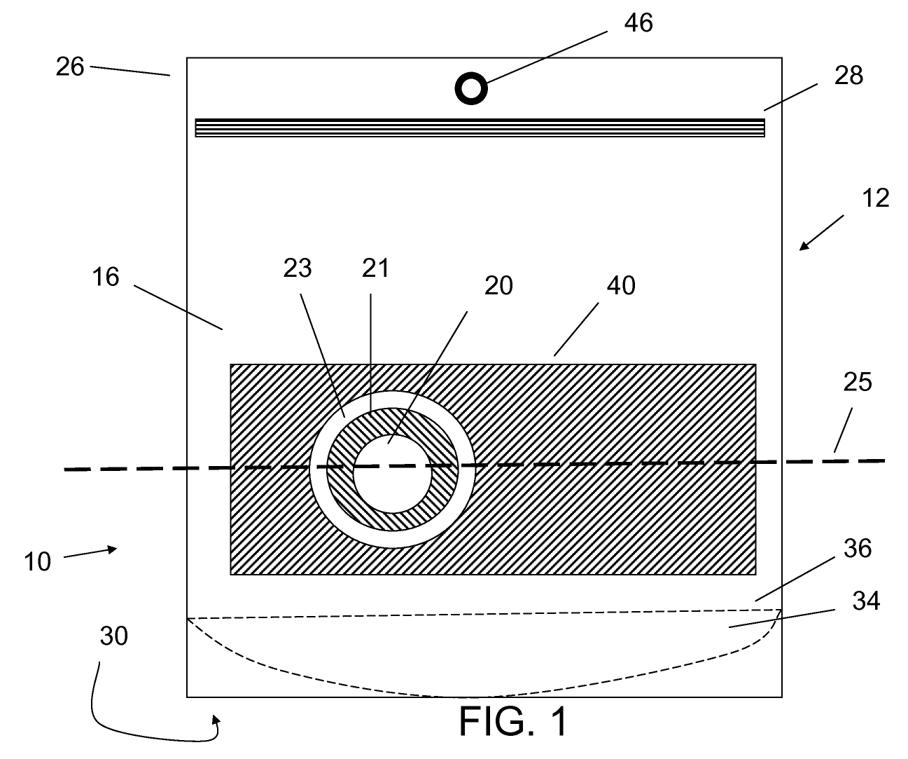

Referring to FIGS. 1 to 5, there are shown five views of one embodiment of the invention which is a re-usable bag trap 10 for wasps and flies. The trap 10 can be either self-supporting or suspended by an eyelet with a tether. The invention comprises a bag 12 of suitable material, preferably of resilient plastic, with or without a bonded barrier material.

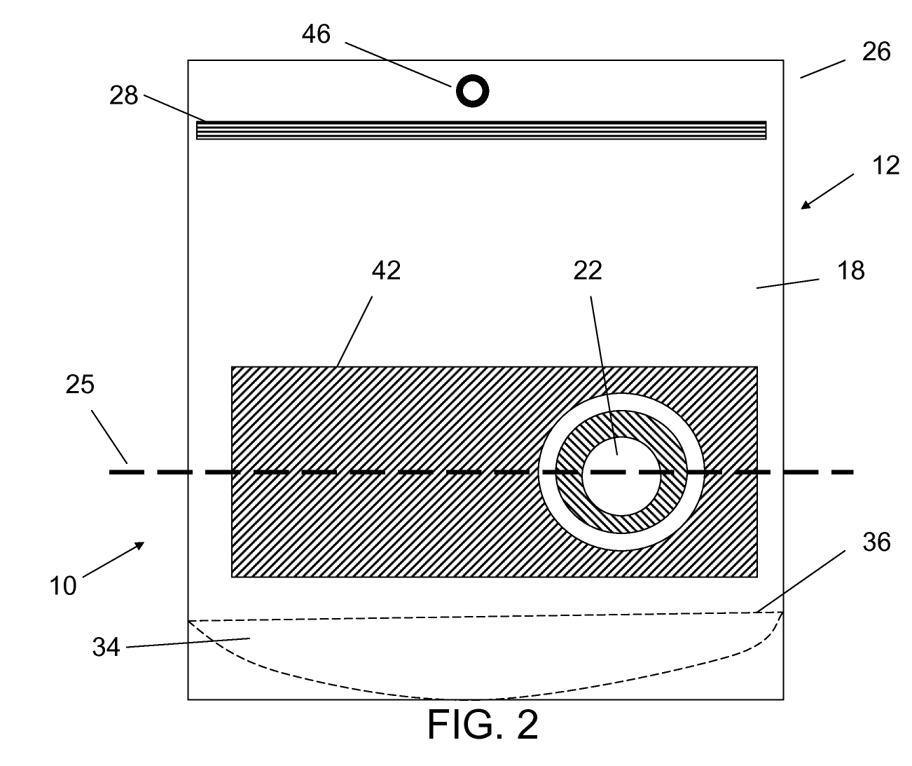

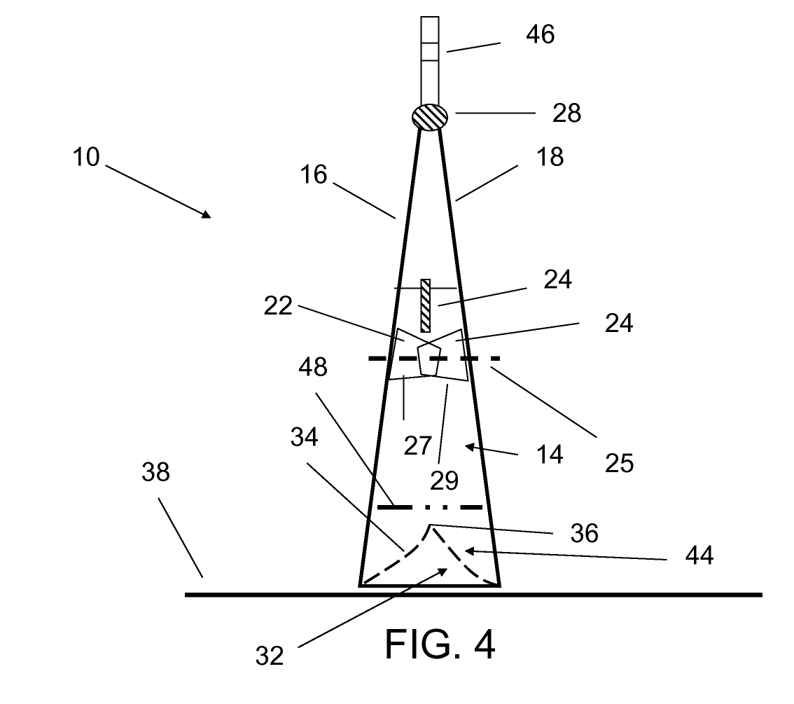

As seen in FIG. 1, the bag 12 comprises a first side wall 16 which in a preferred embodiment is transparent. (There is also a second opposite transparent side wall 18 which is visible in FIG. 2.) A first circular entry portal for wasps 20 penetrates the first transparent side wall 16 so that the portal 20 is in communication with the interior of the wedge-shaped chamber 14 (see FIG. 4). The portal 20 comprises a sloped portion 21 and an outside flat surface 23 which forms a flange for adhesive attachment to the side wall 16. The outer surfaces of both are roughened to facilitate traction by insects landing on and entering the trap.

FIG. 2 illustrates a second opposite circular entry portal 22 for wasps which penetrates the second transparent side wall 18 and communicates with the interior of the wedge-shaped chamber 14 (see FIG. 4). The second portal 22 is fastened adhesively to the side wall 18. To the interior of the entry portals 20 and 22 there are frusta-conical passageways 27 and 29 (see FIG. 4). These passageways 27, 29 are designed to foil attempts by the insects to leave the trap, in part by having a smooth surface facing the interior of the chamber so that traction by captured insects is impeded. In this way, insects can enter the interior chamber 14 from either sides of the trap through the respective portals 20 or 22 but find it difficult to leave.

As seen in FIGS. 1 and 2, the first and second transparent side walls 16, 18 respectively include translucent rectangular portions 40 and 42 which are of a colour suitable for attracting wasps. In one embodiment of the invention this colour is yellow, which is known to be a preferred wasp attractant colour. Other colours effective in attracting such pests can also be used. In another embodiment of the invention, the coloured surface may be in a matte finish, so as to reduce reflection which may deter attracted insects. The rectangular portions 40, 42 span each entry portal. In other embodiments of the invention, the portions 40, 42 can be modified into different shapes, e.g. ovals, circles, trapezoids or irregular shapes.

FIGS. 1 and 2 demonstrate that the first portal 20 and the second portal 22 are offset horizontally along dotted line 25, which appears for reference. Offsetting portals 20 and 22 permit the bag 12 to fold reasonably flat for storage and packaging because the portals 20, 22 do not collide with one another. Once the bag 12 is expanded to its operating position, as show in FIG. 4, the portals 20, 22 are on opposite side walls from each other, with the conical passageways 27, 29 extending inwardly. Since the portals 20 and 22 are offset along the horizontal, they do not connect and thus discourage the insects from flying into the first portal 20 and out the opposite portal 22.

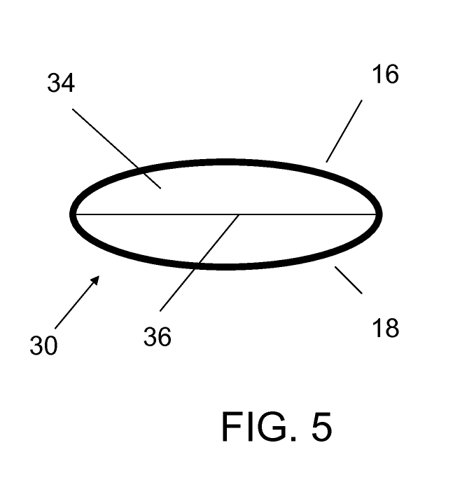

The bag 12, as seen in FIGS. 1 and 2, has a sealable top end 26 comprising a releasable sealing strip 28 which can be opened as required for cleaning the trap and then resealed. In this way, the trap 10 is reusable and prevents unnecessary waste. The bag 12 has a sealed bottom end 30 comprising a bottom surface 32 in turn comprising an oval-shaped bottom member 34 having a longitudinal fold line 36 (see FIG. 5).

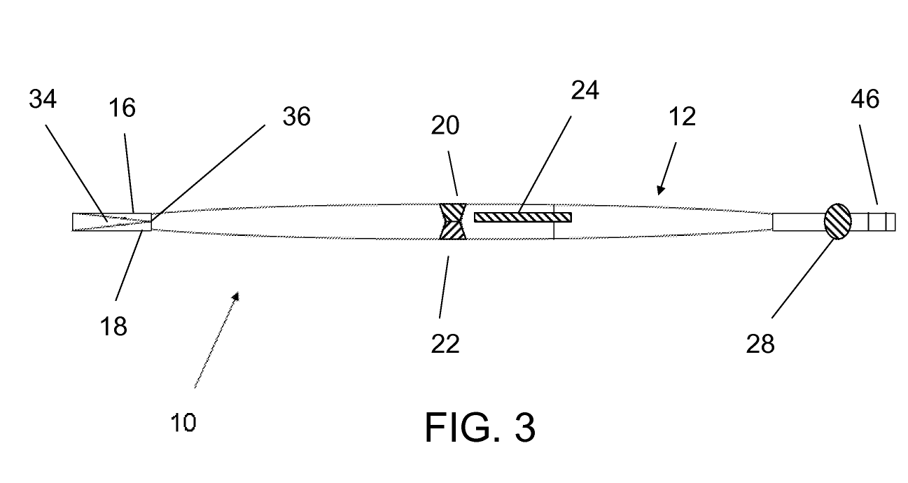

The trap 10 can have a first generally flat configuration for storage as shown in FIG. 3 and a second expanded operating configuration as shown in FIG. 4. In the second expanded operating configuration shown in FIG. 4, there is formed a wedge-shaped internal chamber 14 for trapping and containing insects. The trap 10 can be suspended from a tether or hook using reinforced eyelet 46, if preferred.

Referring specifically to FIG. 3, which illustrates an end view the bag 12 in a flat configuration for storage, the fold line 36 acts to enable the oval-shaped bottom member 34 to fold symmetrically so that it rests in a folded configuration within the bottom region of the side walls 16 and 18. Bait attractant such as 1-heptylbutyrate, available from Contech Enterprises Inc., can be suspended inside the bag 12 above the portals 20, 22 and is shown as 24.

Referring specifically to FIG. 4, when the bag 12 is in the expanded operating configuration, the oval-shaped bottom member 34 unfolds to form a bottom surface 32. When in its expanded configuration as shown in FIG. 4, the sidewalls 16 and 18, with bottom surface 32, enable the trap to be self-supporting on flat surfaces 38 such as picnic tables.

Continuing to refer to FIG. 4, the bag 12 is adapted to contain a predetermined volume of fluid 44 (usually water) for drowning insects. To attract insects to the trap 10, a water soluble chemical lure or emulsifiable concentrate can be added to the water. Alternatively, an attractive chemical lure can be floated on the surface of the fluid within the trap 10. The weight of the water acting on the bottom surface 32 acts to expand the bag, keeping the walls 16, 18 and entry portals 20, 22 apart, and allowing the inner chamber 14 to expand to its full wedge-like volume. The water also acts to stabilize the base of the bag 10 so that it does not easily tip over when set on a flat surface. The water preferably fills the bag 12 up to a suitable level as indicated by dotted line 48.

FIG. 5 depicts a bottom view of the sealed bottom end 30 of the trap in its expanded form. The longitudinal fold line 36 is shown as well as first sidewall 16 and second sidewall 18.

### Example 1

### Test of Bag Traps for Yellowjackets

Prototype bag traps were manufactured from commercially-available plastic bags (19×30 cm). The bags tapered to a zip-lock top and the bottom expanded when liquid was added (approximately 425 mL per bag.

The bags were fitted with small or large entry ports made from funnels used to deliver food pastes (e.g. mustard) from squeezed plastic containers. The inward-directed funnels were on opposite sides of the bags, and were offset laterally, so that the bags laid quite flat when not in use. They were placed vertically at mid-level of 10×16 cm bogus labels on each side of the bags made by painting the area with yellow paint (Painter's Touch Sun Yellow gloss latex, RUST-OLEUM Corp, Toronto, Ontario). The bogus labels were located 7 cm from the bottom of the traps. It is known that yellowjackets are attracted to “buttercup yellow”, which Sun Yellow paint mimics.

Experiments were set up as randomized, complete blocks, with 12 replicates. Between trap distance was ≧5 m. Experiments were run in commercial orchards east of Kelowna, BC, Canada. All traps were baited with one heptyl butyrate flexlure (Contech Enterprises Inc., Delta, BC, Canada) taped to the inside of the trap. The fluid in the bottom of the trap was 50% apple juice with a dash of laundry detergent added to ensure capture of wasps. Captured yellowjackets were identified to species in the field using a pictorial key (Akre, R. D. et al. 1980, Yellowjackets of America north of Mexico, USDA Agriculture Handbook No. 552, p. 23). Means were analyzed by ANOVA followed by the Tukey-Kramer LSD test. In all cases, α=0.05.

Experiment 1 was run at the Brar Orchard from 8-10 Jul. Sufficient numbers of yellowjackets were captured (1-2 per trap) to conduct a statistical analysis, but only for all species combined and not to compare means. To test the new disposable traps against larger populations, two additional experiments were run, both with treatments identical to those in Experiment 1. Experiment 2 was run at the Runzer Orchard from 7-13 Aug., and Experiment 3 was run at the Brar Orchard from 13-15 Aug.

There was no significant difference in Experiment 1 between large standard control traps (Contech Inc.) baited with heptyl butyrate and 50% apple juice, and any disposable bag trap (2 or 4 small entry ports or two large entry ports) baited with the same lures (Table 1). Numerically, traps with two small entry ports were superior at a mean of two wasps per trap.

The inventors considered the lack of difference to be significant because it appeared that the bag trap was competitive with the standard large control trap. Also significant is that about two hours after experimental set up, many of the disposable traps had already caught yellowjackets, while very few of the large control traps had done so. However, the inventors judged that further experimentation would be needed with larger populations.

TABLE 1
Ranked catches of yellowjackets (all species combined)
in Exp. 1 testing prototype disposable traps of three
different designs, Brar Orchard, Kelowna BC, 8-10 Jul. 2008.
Respective percentages of 75 yellowjackets captured are:
Vespula pennsylvanica 36.0%, V. atropilosa 36.0%,
V. vulgaris 22.7% and V. consobrina 5.3%.

| | NUMBER OF |
|---|---|
| | YELLOWJACKETS |
| TRAP TYPE | CAPTURED (MEAN ± SE)¹ |
| Bag prototype, two small entry ports | 2.0 ± 0.5 |
| Bag prototype, four small entry ports | 1.5 ± 0.4 |
| Bag prototype, two large entry ports | 1.3 ± 0.6 |
| Standard large trap | 1.3 ± 0.4 |

¹ANOVA statistics: F = 0.44, df = 3.44, P = 0.7230.

The results in Experiments 2 and 3 generally upheld those in Experiment 1 (Table 2). In Experiment 2, there were significant differences among treatments for V. pennsylvanica and all yellowjackets combined, but only for V. pennsylvanica were the differences great enough for a comparison between means. This comparison showed that traps with two large entry ports, or two small ones caught statistically similar numbers of yellowjackets as the standard large (control) traps, while those with four small entry ports caught significantly fewer yellowjackets than the controls. In Experiment 3, there was no significant difference among treatments, either for V. pennsylvanica or for all yellowjackets combined.

On balance, the results of Experiments 2 and 3 showed that bag traps with two large entry ports performed more consistently than traps with two small entry ports (Table 2). Therefore, traps with two large entry ports were chosen for further commercial development.

TABLE 2
Ranked catches of yellowjackets in Exp. 2 and 3 testing prototype disposable
traps of three different designs. Exp. 2, Runzer Orchard, Kelowna BC,
7-13 Aug. 2008. Exp. 3, Brar Orchard, Kelowna BC, 13-15 Aug. 2008.
Respective percentages of 163 yellowjackets captured in Exp. 2 are:
Vespula pennsylvanica 68.7%, V. atropilosa 25.8%, and V. vulgaris 7.4%.
Respective percentages of 351 yellowjackets captured in Exp. 3 are:
Vespula pennsylvanica 90.67%, V. atropilosa 4.7%, and V. vulgaris 5.1%.

| | | | NUMBER OF | |
|---|---|---|---|---|
| | | | YELLOWJACKETS | |
| Experiment | | | CAPTURED^{a,b} | |
| No. | SPECIES | TRAP TYPE | RANGE | MEAN ± SE |
| 2 | V. pennsylvanica | Standard large trap | 1-11 | 3.7 ± 1.0 a |
| | | Bag prototype, two large | 1-11 | 3.3 ± 0.8 ab |
| | | entry ports | | |
| | | Bag prototype, two small | 0-5 | 1.5 ± 0.5 ab |
| | | entry ports | | |
| | | Bag prototype, four small | 0-2 | 0.9 ± 0.2 b |
| | | entry ports | | |
| | All | Standard large trap | 1-14 | 5.2 ± 1.3 |
| | yellowjackets | Bag prototype, two large | 1-16 | 4.6 ± 1.2 |
| | | entry ports | | |
| | | Bag prototype, two small | 0-8 | 2.2 ± 0.8 |
| | | entry ports | | |
| | | Bag prototype, four small | 0-5 | 1.8 ± 0.4 |
| | | entry ports | | |
| 3 | V. pennsylvanica | Standard large trap | 0-27 | 8.7 ± 2.2 |
| | | Bag prototype, two small | 2-23 | 7.7 ± 1.6 |
| | | entry ports | | |
| | | Bag prototype, two large | 1-15 | 5.7 ± 1.3 |
| | | entry ports | | |
| | | Bag prototype, four small | 1-11 | 3.7 ± 0.9 |
| | | entry ports | | |
| | All | Standard large trap | 0-30 | 9.6 ± 2.5 |
| | yellowjackets | Bag prototype, two small | 2-24 | 8.3 ± 1.6 |
| | | entry ports | | |
| | | Bag prototype, two large | 1-20 | 6.4 ± 1.6 |
| | | entry ports | | |
| | | Bag prototype, four small | 1-12 | 4.2 ± 1.0 |
| | | entry ports | | |

^{a}ANOVA statistics Exp. 2: V. pennsylvanica: F = 3.86, df = 3.44, P = 0.016; all yellowjackets combined: F = 3.26, df = 3.44, P = 0.030. Means for V. pennsylvanica followed by the same letter are not significantly different, Tukey's HSD test, P ≦ 0.05.
^{b}ANOVA statistics Exp. 3: V. pennsylvanica: F = 2.05, df = 3.44, P = 0.120; all yellowjackets combined: F = 1.82, df = 3.44, P = 0.157.

### Example 2

### Test of Bag Traps for Flies

Bag traps manufactured with two large entry ports were tested in comparison with a commercial plastic jar trap fitted with a cylindrical cross bridge open at each end for flies to enter, and with a cut out portion allowing flies to pass from the cylinder into the interior chamber of the trap. Both types of traps were baited with a protein-based lure (Contech Enterprises Inc., Delta, BC, Canada) in water with a dash of detergent added to ensure that captured flies sank below the surface and drowned.

The experiment was run on a dairy farm in Delta, BC from 4-8 Sep. 2009. Eight randomized pairs of traps were suspended from fencing wire, with the between-traps distance ≧5 m. Captured flies in the suborder Brachycera (short-horned flies) were counted, but not sorted further by taxa. The mean catches were compared by a t-test.

The results unexpectedly showed that the bag trap captured twice as many flies (mean±SE=86.5±14.0) as the commercial trap (mean±SE=42.0±7.6). This difference was significant (t=2.84, df=10, P=0.018) This result indicates that the bag trap as designed for yellowjacket wasps is also suitable for other insects.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A trap for insects comprising:
a. a bag having a first generally flat collapsed configuration for storage and a second expanded configuration for operation thereby forming an internal chamber for trapping insects, said bag comprising a first side wall and a second opposite the side wall;
b. an entry portal for insects, said entry portal penetrating said first or second side wall and communicating with said internal chamber; and
c. a suitable attractant in the bag for attracting insects to the entry portal.

2. The trap as claimed in claim 1 including a second opposite entry portal for insects, said second circular entry portal penetrating said side wall opposite the first entry portal and communicating with the internal chamber.

3. The bag as claimed in claim 2 wherein the bag is formed of a resilient plastic.

4. The trap as claimed in claim 3 wherein the plastic includes a bonded barrier material.

5. The trap as claimed in claim 2 wherein the one or more side walls are transparent.

6. The trap as claimed in claim 2 wherein the interior of the chamber contains a fluid.

7. The trap as claimed in claim 2, wherein the bag has a sealable top end.

8. The trap as claimed in claim 2, wherein the bag has a bottom surface comprising an oval-shaped bottom member having a longitudinal axis.

9. The trap as claimed in claim 8, wherein said longitudinal axis comprises a fold line so that when the bag is in a generally flat configuration the oval-shaped bottom member folds symmetrically along the fold line and when the bag is in the expanded operating configuration the oval-shaped bottom member unfolds to form a self-supporting base.

10. The trap as claimed in claim 5, wherein the first and second transparent side walls include a translucent portion spanning the first and second entry portals and having a colour suitable for attracting insects.

11. The trap as claimed in claim 10 wherein the translucent portion has low reflectance and is rectangular.

12. The trap as claimed in claim 10 wherein the translucent portion has a shape other than a rectangle.

13. The trap as claimed in claim 2 wherein the first portal and the second portal are offset laterally from each other.

14. The trap as claimed in claim 6 wherein the fluid is a predetermined volume of water for drowning insects, the predetermined volume of water stabilizing the trap when placed on a level surface.

15. The trap as claimed in claim 14, wherein the water contains an attractive chemical lure.

16. The trap as claimed in claim 2 wherein an insect attractant is located within the interior of the trap above the two portals.

17. The trap as claimed in claim 1 wherein the top region of the trap includes a releasable pressure sealing strip.

18. A trap as claimed in claim 1 wherein the top region of the trap includes an eyelet which enables the trap to be suspended from an object.
